(19) United States
(12) Patent Application Publication
(10) Pub. No.: US 2006/0163941 A1
(43) Pub. Date: Jul. 27, 2006

(54) Brake by-wire actuator

(76) Inventors: Holger Von Hayn, Bad Vilbel (DE); Jurgen Schonlau, Walluf (DE); Manfred Ruffer, Sulzbach (DE); Wolfgang Ritter, Oberursel/Ts (DE); Milan Klimes, Zornheim (DE); Torsten Queisser, Frankfurt (DE); Alfred Eckert, Mainz-Hechstheim (DE); Christian Albrich Von Albrichsfeld, Darmstadt (DE)

Correspondence Address: RATNERPRESTIA, P O BOX 980, VALLEY FORGE, PA, 19482-0980, US

(21) Appl. No.: 10/520,683

(22) PCT Filed: Jul. 9, 2003
(86) PCT No.: PCT/EP03/07406

§ 371 Date: Jul. 14, 2005

(30) Foreign Application Priority Data
Jul. 9, 2002 (DE) 102 30 865.9
May 23, 2003 (DE) 103 23 825.5
May 28, 2003 (DE) 103 24 503.0

(51) Int. Cl. B60T 8/34

(52) U.S. Cl. 303/155; 303/113.4

(57) ABSTRACT

The present invention relates to a brake-by-wire actuator for actuating the brake system of a motor vehicle, comprising a simulator which can be acted upon by a brake pedal, with a signal of an actuation sensor being sent to an electronic control unit which controls a pressure source in response to the signal of the actuation sensor, and wherein an output of the pressure source is connected to a distributor device for the brake force and actuates individual wheel brakes of the vehicle, also comprising means for enabling actuation of the brakes by muscular power within a fallback mode. In order to provide an improved fallback mode in a brake-by-wire actuator, according to the invention, a lost travel is provided between a first actuation component such as a brake pedal in particular or a component articulated at the brake pedal and an actuation component that is connected downstream in the flux of force, in particular an input member, in order to uncouple the first actuation component mechanically from the reactions of force of the motor vehicle brake system in the by-wire mode.

### TECHNICAL FIELD

The present invention relates to a brake-by-wire actuator for actuating the brake system of a motor vehicle, comprising a simulator which can be acted upon by a brake pedal, with a signal of an actuation sensor being sent to an electronic control unit which controls a pressure source in response to the signal, and wherein an output of the pressure source is connected to a distributor device for the brake force and actuates wheel brakes, also comprising means for enabling actuation of the brakes by muscular power within a fallback mode.

### BACKGROUND OF THE INVENTION

A generic brake actuation device has been disclosed already in an electrohydraulic brake system (EHB). The device is based on uncoupling the brake pedal hydraulically from the hydraulic reaction forces of the brake system by the provision of electromagnetic separating valves isolating a master brake cylinder hydraulically from the brake system. The brake pressure in the wheel brakes is controlled electronically (by-wire) in that the signal of the actuation sensor, which is e.g. configured as a pedal travel sensor, is sent to an electronic control unit and, after data processing, to an electrohydraulically operating hydraulic unit (HCU) with solenoid valves so that an appropriate amount of brake pressure can be applied to individual or all wheel brakes in response to the output signal of the HCU by using the pressure source. The vehicle operator feels only the reaction forces of a simulator.

In order that the brake system is operable also in a de-energized condition that is due to a defect, a so-called hydraulic—because de-energized—fallback mode is made use of, within which brake actuation is ensured by use of a sophisticated safety concept. In this arrangement, various processes of evaluating sensor signals allow partial deactivations of defined functions such as the brake assist system, driving stability control (ESP) and, eventually, an actuation by way of muscular power because the by-wire mode with simulator function is disconnected and a tandem master brake cylinder still provided is connected hydraulically to the wheel brakes. A like design of the fallback modes is considered indispensable.

Current developments of vehicle technology, however, also take into consideration regenerative braking methods allowing a conversion of the kinetic vehicle energy to be reduced into electric energy by superimposing a generator that feeds a mains power supply. This arrangement can e.g. by realized by means of a so-called starter-generator combination (ISAD—Integrated Starter Alternator Damper), wheel hub drives, or in any other way so that the generator operation takes over braking functions at least to a certain extent. This constellation demands a further developed safety concept for the fallback mode because regenerative brake functions, such as the generator operation in particular, can be available even in the event of leakage in wheel brake circuits or a partial failure of electrical functions of the electrohydraulic vehicle brake system, for example.

Conventional brake systems are configured in such a way that no lost travel or no appreciable lost travel occurs. This imparts the feeling to the vehicle operator of achieving a direct and instantaneous as well as easy-to-dose braking effect, what is generally desirable. This behavior is easy to achieve for the by-wire mode in brake-by-wire systems, however, not in the case of a change to a mechanical through grip within a so-called mechanical or hydraulic fallback mode.

### BRIEF SUMMARY OF THE INVENTION

An object of the invention is to disclose an improved by-wire actuator which is well suited for implementation into various, in particular regenerative brake systems, and exhibits good actuation properties in the by-wire mode as well as in the mechanical/hydraulic fallback mode.

According to the invention, this object is achieved in that a lost travel a is provided between an actuation component such as a brake pedal or a component articulated at a brake pedal and a second actuation component that is connected downstream in the flux of force, in order to uncouple the brake pedal mechanically from the reactions of force of the motor vehicle brake system in the by-wire mode. Consequently, the actuation component has a divided design, and the two parts are spaced a distance ‘a’ from one another so that the flux of force is interrupted. The combination of features indicated in the main claim provides the precondition for a mechanical uncoupling of the brake pedal from subsequent actuation components in the by-wire mode with a simultaneously direct through grip possibility in the fallback mode (non-by-wire mode).

The invention permits an unlimited functionality and a surprisingly simple brake-by-wire actuator. Merely the lost travel ‘a’ must be overcome until the hydraulic/mechanical fallback mode is reached before braking pressure builds up in the wheel brakes. More specifically, it must be ensured in the by-wire mode that a sufficient distance ‘a’ is permanently given for mechanically uncoupling the brake pedal.

In order to further improve the actuation feeling upon activation of the fallback mode operated by muscular power, a favorable embodiment of the invention suggests the provision of a means in order to automatically reduce the lost travel after the by-wire mode is left and at the commencement of a brake actuation operated by muscular power. The means may e.g. be actuated by means of an electric, electromagnetic, hydraulic, pneumatic or even pyrotechnical actuator, which will automatically adopt a closing position for reducing the lost travel in the event of a signal change or in the absence of energization. The distance ‘a’ is so-to-speak reduced or bridged in the closing position of the actuator. Consequently, it is no longer necessary to overcome the lost travel ‘a’ so that even the fallback mode furnishes a direct brake feeling. In addition, externally actuated conditions are possible due to the prevailing distance ‘a’ in the by-wire mode without conveying any direct force reactions to the vehicle operator. Producing the mentioned conditions is reserved for the simulator.

According to a first constructive embodiment of the invention, the means is provided as a clutch between two actuation components. Said clutch can comprise a block-shaped body as an active element which e.g. has the shape of a wedge and is configured as a slide being movable in a form-fit manner into the lost travel ‘a’ between the actuation components, thereby bridging the lost travel. Further, said clutch may comprise a spring for the elastic preload of the block-shaped body and a solenoid for returning or keeping back the block-shaped body in the opening position. In the non-energized condition, the clutch will automatically tend to adopt the closing position because the spring is used to provide the flux of force.

Preferably, a clutch is provided which mechanically couples the brake pedal in its position relative to the subsequent actuation component directly to said at the time of request for actuation, said coupling being effected on a command to mechanically couple the brake pedal to the actuation component, in particular upon failure of the booster. The point of application of the brake pedal will not approach the point of application of the actuation component in the longitudinal direction thereof. Instead, the brake pedal makes catch directly at that point where the actuation component is disposed at the instant. This may e.g. be done by a radially moved pawl of the wedge described which interconnects the two actuation components in the position they presently assume.

In a preferred embodiment of a clutch, the brake pedal is coupled to a clutch shaft pivotally mounted in its longitudinal direction as an actuation component, which in dependence on its rotary position relative to a subsequent actuation component is either longitudinally displaceable in an actuating direction relatively to said or is engaged so as to be undisplaceable in an axial direction. In this arrangement, the clutch shaft and the actuation component include projections serially arranged in their longitudinal direction, and in a first rotary position of the clutch shaft in relation to the actuation component, the projections of the clutch shaft and the actuation component are disengaged, while in a second rotary position at least one projection at least one projection of the clutch shaft is engaged with a projection of the actuation component. The features mentioned hereinabove allow blocking or releasing the flux of force between the separated actuation components for the fallback mode in an extremely short time by way of a simple rotation.

When several rows of projections are provided at a predetermined angular distance over a periphery of the actuation components (of the clutch shaft), it becomes especially possible to transmit great forces in a compact construction.

In another favorable embodiment of the invention, the clutch shaft is equipped with a longitudinal bore that is open towards the subsequent actuation component. One end of this actuation component projects into said bore, and peripheral surfaces of the end of the actuation component and of the longitudinal bore in the clutch shaft carry the projections.

Advantageously, the clutch includes a spring whose first end is supported on a housing of the clutch and whose second end is supported on a transmission member, with said transmission member being connectable to the clutch shaft pivotally mounted in its longitudinal direction, with said clutch shaft being longitudinally displaceable in relation to the transmission member in dependence on its rotary position with respect to the transmission member or being in engagement with the transmission member in an axial direction by way of projections.

The clutch shaft is in engagement with the actuation component and disengaged from the transmission member in at least one first rotary position and disengaged from the actuation component and in engagement with the transmission member in at least one second rotary position.

A particularly simple mechanical clutch between the subsequent actuation component and the brake pedal is achieved in that the brake pedal is connected to a clutch shaft pivotally mounted in its longitudinal direction and being longitudinally slidable in relation to the actuation component in dependence on its rotary position relative to the actuation component or being in engagement with the actuation component in an axial direction. Thus, radial or axial movement of a coupling member does not take place but a rotation that is easier to achieve under mechanical aspects.

Mechanical coupling shall be achieved by a rotation irrespective of which position the actuation component and brake pedal adopt in relation to each other. A straightforward solution is rendered possible in a favorable improvement of the invention because both the clutch shaft and the actuation component are equipped with serially arranged projections in their longitudinal direction, and in a first rotary position of the clutch shaft relative to the actuation component, the projections of clutch shaft and actuation component are disengaged, while at least one projection of the clutch shaft is in engagement with a projection of the actuation component in a secondary position.

To increase the force that can be transmitted in a longitudinal direction between the brake pedal and the actuation component, several rows of projections are distributed at a predetermined angular distance over a periphery of the actuation component and the clutch shaft.

The clutch shaft is used to transmit the force from the brake pedal to the actuation component. To reach centering, it is advisable according to an improvement of the invention that the clutch shaft is furnished with a longitudinal bore that is open towards the actuation component, into which one end of the actuation component projects, and that peripheral surfaces of the end of the actuation component and the longitudinal bore in the clutch shaft carry the projections. The actuation component and the clutch shaft are thus centered in each other and guided in a longitudinally slidable manner.

A reactive force of the master brake cylinder or of the subsequent actuation component on the brake pedal is missing because the wheel brakes are electrically actuated in the by-wire mode. To reproduce this force, a corresponding force generator (simulator, force-feedback pedal) is used, for example a spring or a motor, which act on the brake pedal in opposition to its actuating direction in an appropriate fashion. Preferably, this is achieved in that the clutch is provided with a compression spring which is supported with a first end on a housing of the clutch and with a second end on a transmission member, with said transmission member being connectable with the clutch shaft pivotally mounted in its longitudinal direction, with said clutch shaft being longitudinally displaceable relative to the transmission member in dependence on its rotary position in relation to the transmission member, or being in engagement with the transmission member in an axial direction.

To prevent that the brake pedal must act against the master brake cylinder and against the force generator (compression spring) upon entry into the fallback mode, in a favorable improvement of the invention, the clutch shaft is in engagement with the actuation component and disengaged from the transmission member in at least one first rotary position and is disengaged from the actuation component and in engagement with the transmission member in at least one second rotary position. Thus, the clutch shaft connected to the brake pedal either acts only on the compression spring in the normal case or only on the actuation component in the fallback mode.

Most different devices can principally be used as a pressure source. For example, a hydraulic booster with at least one hydraulic pump can be provided which is actuatable by electric signals in the by-wire mode. In the fallback mode, the wheel brakes are operated depending on muscular power and hydraulically by way of a master brake cylinder. To allow an impulse-type pressure output of the pump that is principally effective with inertia, the pump feeds a high-pressure accumulator.

According to another alternative, the pressure source includes a pneumatic booster and additionally a hydraulic pump, which is actuated for example in the event of a defect of the pneumatic booster or when the boosting is insufficient. Besides, a so-called active—that means independently operable—pneumatic booster can be provided as a pressure source, which is actuatable by electric signals in the by-wire mode and mechanically by way of the actuation components in the fallback mode.

It is furthermore possible to arrange for an electromotively operable master brake cylinder for boosting purposes.

The following advantages apply to all types of booster constructions and will be explained exemplarily by way of the example of a pneumatic brake booster. The advantage of a pneumatic booster in combination with an electromechanically actuated simulator involves that the position of an actuation component of the booster which, in turn, depends on the position of the diaphragm plate of the booster, can be fixed by programming in the desired manner in dependence on the position of the brake pedal and, thus, of the output signals of the actuation sensor. More specifically, the lost travel ‘a’ can be adjusted to predefined values in dependence on marginal conditions sensed by sensors.

As explained hereinabove, individual positions of the brake pedal can be associated with a pertinent position of the subsequent actuation component and, thus, in particular with the position of the diaphragm plate of the pneumatic booster. The result is that the brake pedal travel can be shortened and the lost travels can be minimized to the extent necessary. On the contrary, sufficient displacements of the diaphragm plate and, thus, of the actuation component of the booster can be associated with only insignificant movements of the brake-pedal-side actuation component out its zero position. More specifically, a sufficient distance ‘a’ is generated in any case.

The actuator of the invention allows performing also the functions that can be achieved by means of a so-called optimized hydraulic brake system by using a vacuum brake booster (OHVB). In OHBV systems an insufficient vacuum brake booster function is compensated by other means. For example, appropriate sensors are used to measure the differential pressure in pneumatic booster pressure chambers and, in addition, the hydraulic braking pressure that is generated in the brake system by the pneumatic booster, and compared to a request of the driver. The driver's request can be tapped, for example, from the actuating position of the brake pedal. If, however, the measured brake pressure differs from the driver's request to a sufficient extent, a hydraulic pump or any other element will be actuated to ensure compensation of the pressure deficit.

When the vacuum brake booster, the master brake cylinder, or the subsequent distributor device is furnished with an appropriate sensor, for example a pressure sensor in the master brake cylinder, it is hereby likewise possible to determine the system pressure and enable the OHBV function. Sensors can be used with respect to the vacuum brake booster, which e.g. determine displacement of a diaphragm plate by means of a travel sensor, or by employing a pressure sensor to determine pressure on an elastic reaction element (reaction plate) of the booster. The signal of the travel sensor can be used to enable a brake assist function (BA).

It is furthermore favorable that the reactive effect exerted by the simulator on the brake pedal is optionally adjustable by programming in dependence on the boosting of the booster or the output pressure of master brake cylinder. Thus, for example, the start up of the pump at too low output pressure or the case that a nominal value is not reached by way of the simulator increasing the reaction force applied to the brake pedal can be signaled to the driver (e.g. by a stronger force-back). It is of course also possible to connect only the supplementary boosting means and do without a feedback in order not to alarm the driver.

Of course other possibilities of display are also feasible as a substitute for the force-back, such as an optical alarm or an aural signal by using corresponding display elements.

The possibility of programming the desired booster output in dependence on the position of the brake pedal will allow optionally adapting also the brake pedal feeling or the total boosting effect (sum of e.g. the vacuum brake booster effect and the additional boosting effect). Thus, for example, the boosting ratio (ratio between output force and input force) can be kept low at lower brake forces in the sense of greater ease of dosing, while a high boosting ratio can be chosen with average brake forces, what is then gradually reduced in the transition to the point of maximum boosting of the brake booster (saturation) in order to avoid an abrupt change and problems in dosing.

A particularly great advantage of the invention is achieved in that in the event of failure of electric actuating signals of an active vacuum brake booster, in particular in the event of failure of an energy supply of the brake actuation device, the booster can be actuated directly mechanically, with the result of having provided a secured fallback mode when the electronics fails. In this case, a pneumatic booster operates like a conventional pneumatic brake booster, while the hydraulic boosting ratio in the master brake cylinder comes into effect in hydraulic boosters.

A grading of the fallback modes can also be provided in dependence on the sensors available. If, for example, one of two brake circuits fails, boosting can be rated so that higher brake pressure is fed to the intact brake circuit. When the vehicle is in the limit range of driving stability, the use of anti-skid measures such as anti-lock system (ABS) or Electronic Stability Program (ESP) is advisable. Advantageously, the failure of a brake circuit will trigger an alarm to the driver by way of the above-mentioned display elements.

The brake actuation device of the invention can be employed in a very expedient manner also for ESP functions. As the ESP functionality is based on speed jeopardizing driving stability and requires an actuation on each individual wheel without a request for braking, especially quick pressure pulses at selected wheel brakes are significant. This fact is safeguarded according to the invention because a separate booster such as a pneumatically operating booster in particular, a hydraulic booster, or any other means is connected. Conditions are roughly comparable to traction slip control (TCS) during which traction slip shall be reduced due to braking intervention or engine intervention, as the case may be.

Further, the brake actuation device of the invention allows actuation of the booster also in dependence on further parameters that occur irrespective of the position of the brake pedal lever, such as ABS, ESP, Intelligent Cruise Control (ICC), TCS, and other signals being triggered by the driving condition of the vehicle or a driver's request such as when starting to drive uphill.

When an active vacuum brake booster is used, there is no need for a high-pressure accumulator according to the invention, and the brake system is manufactured at low cost and with a compact arrangement. Sensor signals are sent to a central control unit, and the requirement of sensors is generally low. For most of the mentioned functions it is sufficient to use one travel or rotary angle sensor at the brake pedal in order to detect the driver's request, and the travel sensor described for detecting the position of the diaphragm plate and its deviation for the purpose of controlling the booster or for detecting the OHBV case, as well as one hydraulic pressure sensor in at least one brake circuit for determining the actual value in the brake system and for detecting the deviation of the actual value from the driver's request, while taking into account safety provisions and the OHBV mode. When a so-called force-feedback pedal is used, it is possible to assign a rotary angle sensor or travel sensor to the force-feedback actuator (reaction force generator) so that two rotary angle sensors or travel sensors are provided in total in the pedal range, whose signals are sent to the central control unit.

A pneumatic brake booster may additionally dispose of a pneumatic pressure sensor or differential pressure sensor sensing the pneumatic pressure or a pressure difference between pneumatic chambers.

On the basis of all sensor data, the electronic control unit is in a position to detect a malfunction such as the inclusion of air or circuit failure in a brake circuit or the entire brake system and initiate appropriate countermeasures, such as the fallback mode in particular.

In addition, the above-mentioned sensor equipment allows detecting the point of maximum boosting of the booster or insufficient vacuum in a vacuum chamber and starting the hydraulic pump by way of the electronic unit for the purpose of additional boosting.

It has been explained in connection with the main claim that the invention permits a mechanical uncoupling of the brake pedal. As the invention presupposes that the booster can be actuated mechanically by way of the brake pedal not only in the fallback mode, but can be actuated by an electric actuation sensor signal in the by-wire mode, it is always possible by a corresponding programming to actuate the booster by a suitable amplification of the electric signal in such a fashion that its actuation component advances in a predetermined distance ‘a’ in front of the mechanical point of application of the brake pedal. As this occurs, the actuation sensor signal depends on the position of the brake pedal so that a defined displacement of the brake pedal also causes actuation of the booster by a predetermined amount, thus entraining its actuation component a corresponding amount of travel. Said travel is chosen such that a defined distance ‘a’ will always remain between the mechanical point of application of the brake pedal at the actuation component and the actuation component itself what leads to the mechanical uncoupling between brake pedal and actuation component.

In case that e.g. the energy supply for the booster or the mode of operation of the booster itself is disturbed, the lost travel will be bridged and the brake pedal will now act mechanically, at least indirectly, on the actuation component of the booster. This means that even in this case it is still possible for the driver to apply the brake, however, the boosting force of the booster being no longer provided. This condition is referred to as fallback mode because the brake actuation device will fall back from the electric actuation of the booster (by wire) into the direct mechanical/hydraulic actuation in the emergency situation mentioned above.

The above-mentioned brake systems are generally based on the electrohydraulic principle with respect to all wheel brakes. It is, however, self-explanatory that the invention may also be employed in a particularly favorable manner in so-called hybrid systems, wherein for example one pair of hydraulic wheel brakes is provided for a front axle and one pair of electromechanical actuators for a rear axle. Systems of this type can even be devised on the basis of a structure of a 12 (14)-volt mains power supply and provide the advantage that in the event of current failure in one fallback mode the hydraulic wheel brakes of the front axle are directly operable nevertheless.

### BRIEF DESCRIPTION OF THE DRAWINGS

FIG. 1 is a first embodiment of a brake actuation device with a vacuum brake booster in a non-actuated condition.

FIG. 2 is a view of the brake actuation device according to FIG. 1 in the working condition.

FIG. 3 is a view of an embodiment with a reduced lost travel.

FIG. 4 is a cross-section taken through the embodiment according to FIG. 3.

FIG. 5 is a cross-section taken through a second embodiment with a reduced lost travel.

FIGS. 6 and 7 show sketches for illustrating a third embodiment with a reduced lost travel.

FIG. 8 is an implementation of a brake actuation device in a hybrid brake system.

### DETAILED DESCRIPTION OF THE PREFERRED EMBODIMENTS

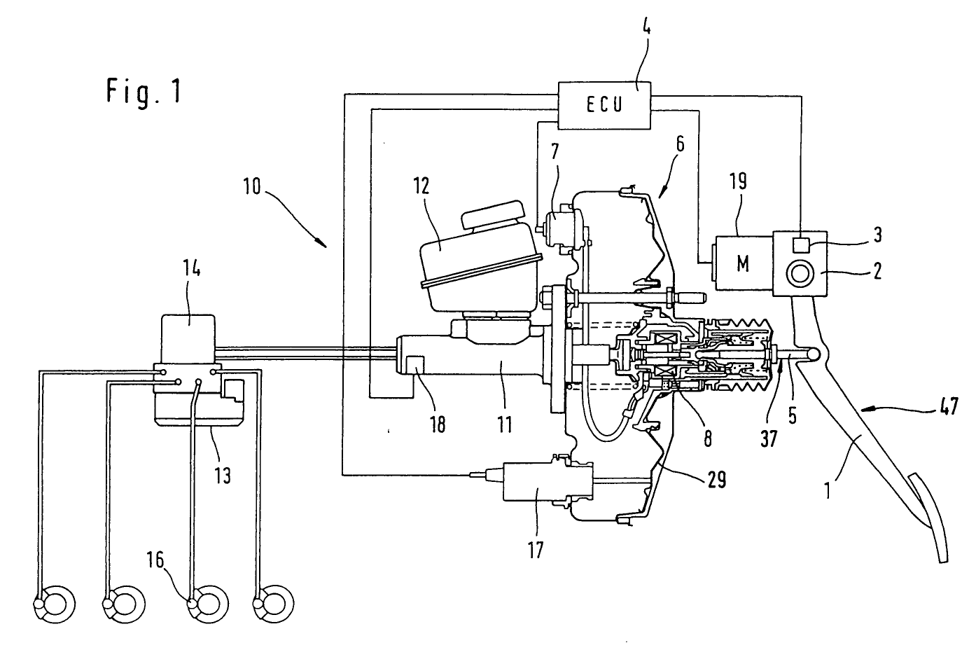

With reference to FIG. 1, a brake actuation device comprises a brake pedal 1 equipped with a simulator 2. Simulator 2 includes at least one, preferably two redundant actuation sensors 3 whose output signals are sent to an electronic control unit 4 (ECU). The brake pedal 1 can be coupled mechanically to the booster 6 by way of an actuation component 5 of a pneumatic booster 6. A connection of this type is usual in the prior art pneumatic boosters 6 because they are actuated mechanically in analog manner by way of the brake pedal 1 and the actuation component 5. In the case of failure of the electronic unit 4, such an actuation is possible also in the brake actuation device of the invention and provides a reliable fallback mode. The booster 6 can be actuated electrically by an output signal of the electronic circuit 4 by way of a connection 7 in addition to the actuation component 5. This is done by means of a magnetic drive 8 which makes catch at the actuation component 5 and is supplied with current signals by way of connection 7.

A distributor device 10 of the brake actuation device comprises a master brake cylinder 11 with an associated reservoir 12 and a valve connection diagram 13 provided with a pump or a pump motor 14, as the case may be. Wheel brakes 16 are actuated by way of the outputs of the valve connection diagram 13. Booster 6 includes a travel sensor 17, while the brake master cylinder 11 includes a pressure sensor 18 at its output.

Simulator 2 can be configured mechanically and include a spring, for example. It is furthermore possible to actuate the simulator electrically for the purpose of a simpler modification of the characteristic curve by equipping the simulator with a motor 19 used to apply the desired reaction force to the brake pedal 1. It is hereby rendered possible that the driver can dose the effect of the brake responsive to force in a known fashion, even if the brake pedal 1 (in the by-wire mode) is mechanically uncoupled from the brake system.

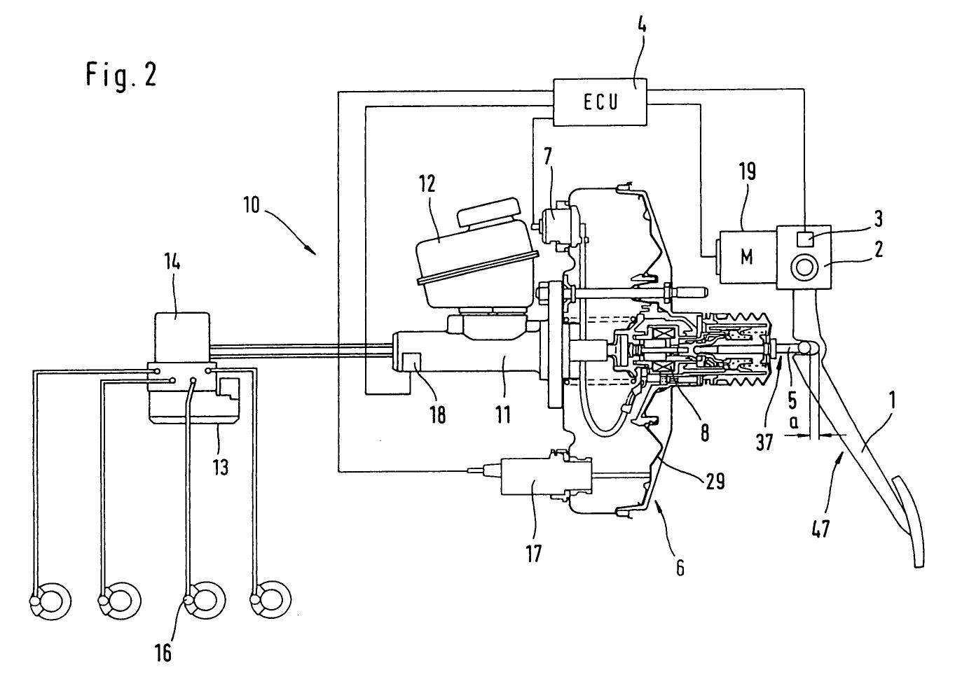

FIG. 2 shows the mechanical uncoupling of the brake pedal 1 from the booster 6 or its input member 5 that is desired in the by-wire mode. When the brake pedal 1 is applied in this condition, the actuation sensor 3 will output a signal to the electronic unit 4 describing the angular position of the brake pedal 1. A corresponding program stored in the electronic control 4 is used to actuate the magnetic drive 8 in dependence on the output signal of the actuation sensor. This corresponds to a defined mechanical input force at the actuation component 5, as it is exerted by way of the brake pedal 1 in the conventional boosters 6. The stored program allows allocating a corresponding movement of the actuation component 5 to a movement of the brake pedal 1 within wide limits by way of the electromagnetic drive 8. This movement is chosen such that the actuation component 5 maintains a sufficiently small distance ‘a’ from the brake pedal so that the actuation component is mechanically uncoupled from the brake pedal 1.

The travel actually covered by a diaphragm plate 29 of the booster 6 can be determined by means of the travel sensor 17, whereby the booster 6 can be controlled to adopt the desired value. When this measured travel will constantly differ from the travel predetermined by the electronic unit 4 in a sufficient extent, for example, by a failure or a defect in the brake system, there will be a report of an error signal triggering suitable processes in the brake system. The pressure sensor 18 will act in or at the output of the master brake cylinder 11 in a corresponding fashion.

The mode of operation of the invention can thus be indicated briefly as follows. An electromechanical control element for generating the brake pedal simulation force detects the driver's request by means of the suitable sensor equipment 3 and conveys it to the ECU 4, which, in turn, actuates the independently actuatable booster 6. Booster 6 moves faster in the direction of the master brake cylinder 11 than the brake pedal 1, thus, the simulator 2 produces by way of motor 19 a force counter to the driver's pedal force, and the driver is uncoupled under normal conditions like in a ‘brake-by-wire’ system. The characteristics of the input force and the delay behavior can be programmed freely and irrespective of one another. If ECU 4 or simulator 2 fails, the system can be operated like any conventional brake system.

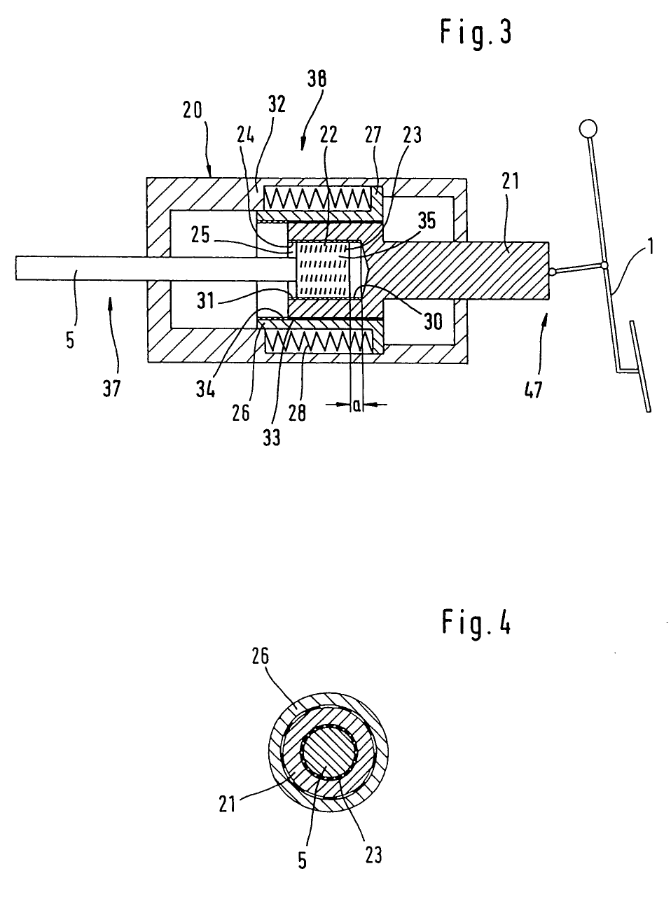

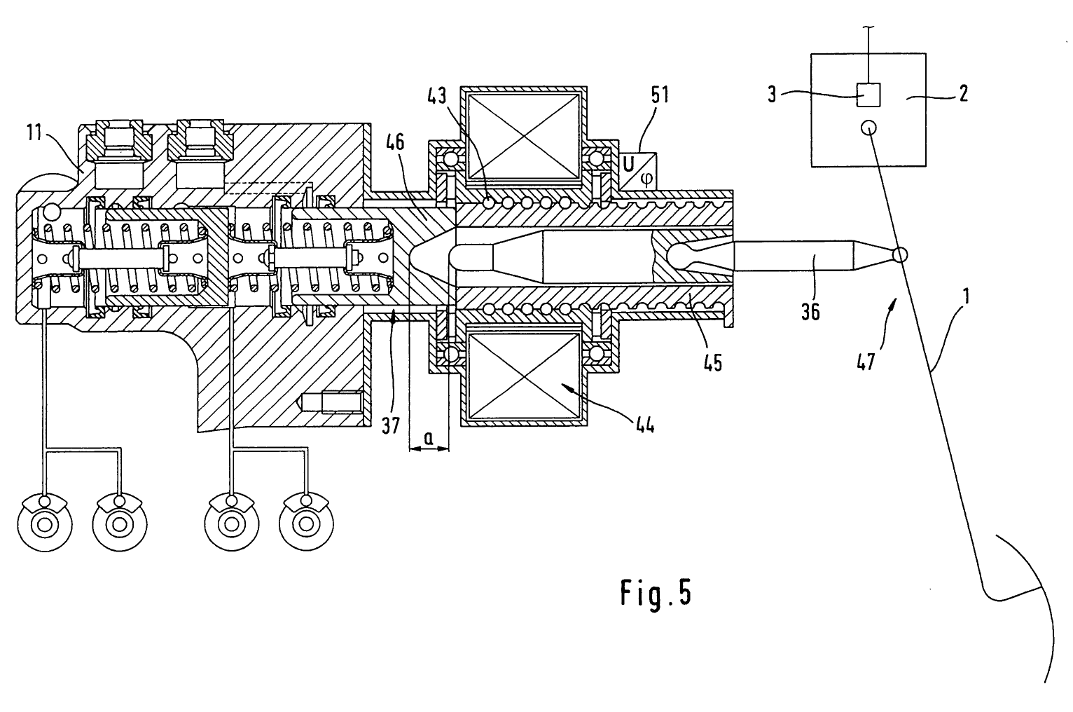

The improvement of the invention according to FIGS. 3 and 4 shows a clutch 20 with a simultaneous simulator function, wherein the actuation component 5 can be used for the operation of the electrically and mechanically actuatable booster 6 or for the actuation of the master brake cylinder 11 or a tandem master brake cylinder. It is essential that the actuation component 5 can be changed in its position by way of control signals of the ECU 4 based on signals of the actuation sensor. This can e.g. occur in that the booster 6 is actuated due to the signals of the actuation sensor or that the master brake cylinder 11 is consequently acted upon by the pressure increase of a hydraulic pump, with the pump in turn being actuated by the ECU 4. Thus, the position of the actuation component 5 depends on the output signal of the actuation sensor. The output signal of the actuation sensor, in turn, depends on the position of the brake pedal 1. A travel sensor required for this purpose is not illustrated in FIG. 3.

The clutch shown in FIG. 3 renders it optionally possible to mechanically couple the brake pedal 1 to the actuation component 5 or to remove this coupling. It is important that in the transition to the mechanical coupling, the actuation component 5 and a clutch shaft 21 of the clutch 20 are interconnected in the relative axial position, which they just assume when the command for the mechanical coupling is given. To this end, a peripheral surface 35 of an end of the actuation component 5 is provided with rows 22 of serially arranged projections 23, associated with which are corresponding rows 31 of projections 30 on a peripheral surface 24 of a longitudinal bore 25 in the clutch shaft 21. These rows 22, 31 are evenly distributed on the peripheral surface 24 and on the end of the input member 5 at regular angular intervals. The distances of the projections 23, 30 are chosen such that the projections 23, 30 of the mentioned components can lie in alignment one behind the other in the event of a corresponding rotary position of the actuation component 5 and the clutch shaft 21. In this case, there is an undercut of the projections 23, 30 of actuation component 5 and clutch shaft 21 so that these two components are coupled to each other in an axial direction. When the actuation component 5 and the coupling clutch 21 are turned by an appropriate angular range out of this position, the projections 30 of the clutch shaft 21 will be placed in the areas of the actuation component 5 lying between the rows 22 and being devoid of projections 23 so that the two components are not coupled to each other in this position in a longitudinal direction.

In the normal operation when the actuation component 5 is uncoupled from the clutch shaft 21, there is a distance ‘a’ between the end of the actuation component 5 and an associated abutment surface on the clutch shaft 21. In the normal operation it is now as before desired that a reaction force acts on the brake pedal 1. This is done in that the clutch shaft 21 is coupled to a transmission member 26 designed as a sleeve. Thus, it is ensured that coupling between the clutch shaft 21 and the transmission member 26 takes place in the rotary position when the actuation component 5 is uncoupled from the clutch shaft 21. Coupling may be effected by appropriate projections 33, 34 on an outside peripheral surface of the clutch shaft 21 and on an inside peripheral surface of the transmission member 26, as has been explained hereinabove with reference to the push rod and the clutch shaft. When the clutch shaft 21 is mechanically connected to the transmission member 26 in a longitudinal direction, a collar 27 of the transmission member 26 acts on a spring 28 that is supported on a housing 32 of the clutch 20, whereby the desired simulator force is exerted.

When the fallback mode is adjusted in the brake system, the clutch shaft 21 is turned in relation to the input member 5 by an appropriate amount, whereby the clutch shaft 21 is coupled to the actuation component 5 but uncoupled from the transmission member 26. The projections 23, 30 can be provided with suitable inlet chamfers so that it is ensured that the projections 23, 30 are crossed one behind the other at surfaces associated with each other (irrespective of the relative position of these components in a longitudinal direction) and hence backgrip each other. It is this way safeguarded that the clutch shaft 21 does not have to overcome the distance ‘a’ before it makes catch mechanically at the actuation component 5. This avoids a lost travel in the magnitude of the distance ‘a’.

The mode of operation of the improvement according to FIGS. 3 and 4 can be described briefly as follows: when the clutch 20 is in normal operation, the flux of force extends from the brake pedal 1 via the clutch shaft 21 into the transmission member 26 and, finally, into spring 28 which is supported on the housing 32. The connection between clutch shaft 21 and transmission member 26 (normal operation) or clutch shaft 21 and actuation component 5 (fallback mode) is carried out by way of specially shafted projections 23, 30, 33, 34, which are designed as thread cords, for example. This safeguards that in the normal condition, the clutch shaft 21 can slide over the actuation component 5 and the clutch shaft 21 is connected to the transmission member 26. A movable drive is used to turn the clutch shaft 21 within limits. It is this way achieved that the clutch shaft 21 is in a flux of force either with the transmission member 26 or with the actuation component 5 in the fallback mode. When the energy fails, the clutch shaft 21 is turned by a resetting mechanism in such a fashion that the projections 23, 30 between actuation component 5 and clutch shaft 21 are in engagement. Thus, the brake pedal force is passed through directly in the direction of the booster 6 of the master brake cylinder 11. As this occurs, the projections 33, 34 between clutch shaft 21 and transmission member 26 are no longer in engagement, and the clutch shaft 21 is thus able to slide through the transmission member 26.

The construction safeguards that upon transition into the fallback mode with the brake pedal 1 already depressed, no brake pedal travel will be lost and the braking effect or the pressure in the brake lines is thus preserved. When the brake pedal 1 is depressed in the normal operation, a driver's request detection unit will sense this action, and the subsequent booster 6 is activated. The result is that the actuation component 5 is pulled away from the clutch shaft 21 so that the two shafts do no touch each other in the normal case. The same applies when the brake is released. The clutch shaft 21 is moved into the initial position at a sufficient rate so that a contact between clutch shaft 21 and actuation component 5 is avoided. Conventional spring systems such as spiral springs, elastomeric springs, cup springs, leaf springs, and cup springs grouped like leaf springs, can be used as spring 28. The advantage of this improvement is the modular construction permitting use in different booster solutions. In addition, no brake pedal travel is lost in the fallback mode in contrast to the previous EHB system. What is more, this solution concerns a ‘dry’ system and, hence, can be integrated in the passenger compartment. Thus, a simulator with an integrated clutch is provided in order to produce the brake pedal feeling in the normal operation by way of a spring 28, while permitting a through grip to the master brake cylinder 11 in the fallback mode. Instead of the threaded cords, rows of balls may be used by means of which the flux of force takes place, similar to screw threads.

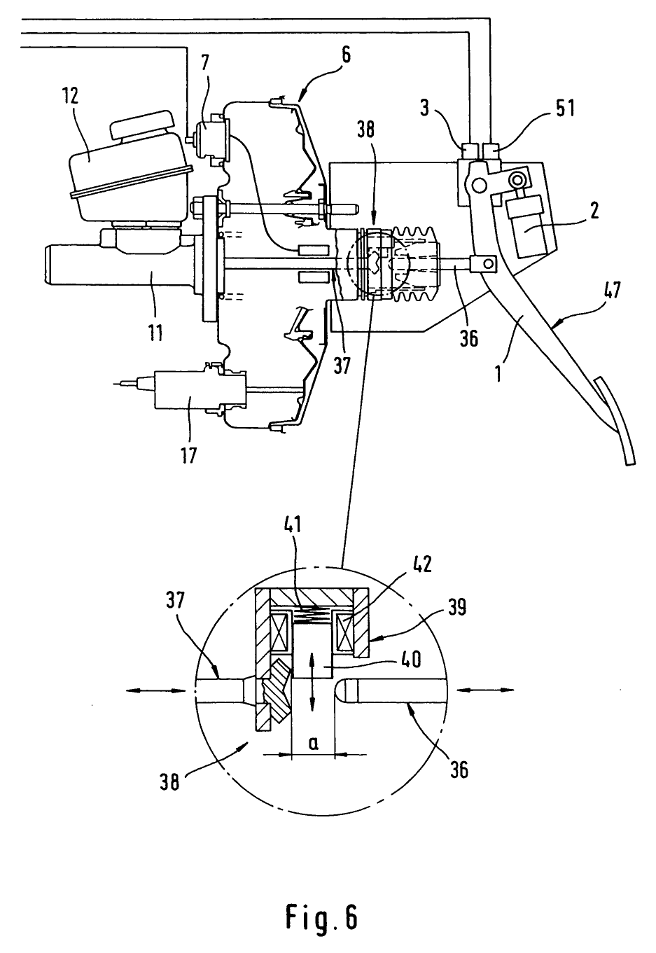

FIG. 5 illustrates a solution for the electromotive actuation of a master brake cylinder 11 by means of a ball screw 43. Sensor 3 detects a movement of a by-wire brake pedal 1, and the signal is sent to a control unit (not shown). As the brake pedal 1 is mechanically uncoupled (distance ‘a’), the driver feels only reaction forces produced by means of a simulator 2. The control unit 4 causes energization of an electric motor 44 what leads to a rotation of the rotor, said movement being converted by means of the ball screw 43 into an axially directed displacement of a tubular sleeve 45 so that this way a hydraulic piston 46 (as a subsequent actuation component) of the master brake cylinder 11 is actuated. Further, at least one actuation component 47 is articulated at the brake pedal 1 and slidably arranged within the tubular sleeve 45. The end of the actuation component 47 has a distance ‘a’ from the subsequent actuation component 46 (hydraulic piston) in the non-actuated condition and in the by-wire mode, what causes uncoupling. The distance ‘a’ is overcome in the fallback mode, and a direct actuation takes place through the brake pedal 1 and the two actuation components 37, 47.

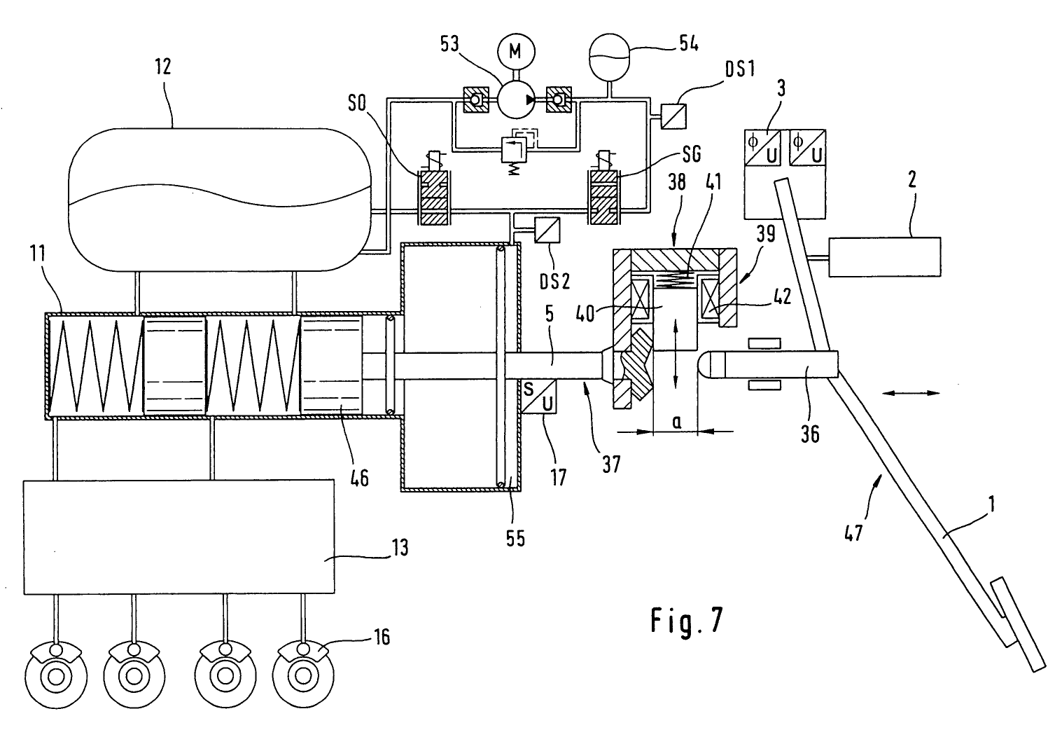

The embodiments according to FIGS. 6 and 7 have a principally coincident clutch 48 for the reduction of the lost travel ‘a’ in the fallback mode. Although this clutch 48 in FIG. 6 is illustrated in connection with a vacuum brake booster 6, different booster concepts such as hydraulic boosters in particular may be used, as has been described hereinabove.

According to FIG. 6, the clutch 48 is disposed between the two actuation components 37, 47 and includes a block-shaped member 40 that can be moved in a form-fit manner into the distance ‘a’ in such a way that the lost travel ‘a’ is bridged in a form-fit manner. The arrangement is comparable with a door latch, and member 40 is shifted automatically between the two actuation components 37, 47 in the fallback mode due to lacking energization of a retaining device for the purpose of reducing the lost travel. An elastically preloaded spring 41 is provided as a drive in this connection, urging the member 40 into the clearance. The function of the device according to FIG. 7 is identical therewith except for the booster.

The hydraulic booster exemplarily shown by way of FIG. 7 comprises a motor-driven pump 53 aspirating fluid from the reservoir 12 and feeding a high-pressure accumulator 54. The high-pressure accumulator 54 can fill a pressure chamber 55 for pressure increase. Pressure is controlled by means of a normally closed solenoid valve (NC) and a normally opened solenoid valve (NO) in a reservoir branch. Volume can be discharged from the high-pressure accumulator 54 into the pressure chamber 55 by opening the NC valve only. One pressure sensor DS 1 and DS 2 respectively is arranged before the NC valve and after the NC valve, and DS 1 permits monitoring the accumulator's filling level for the purpose of switching on the pump, while DS 2 allows the pressure control in the brake circuits.

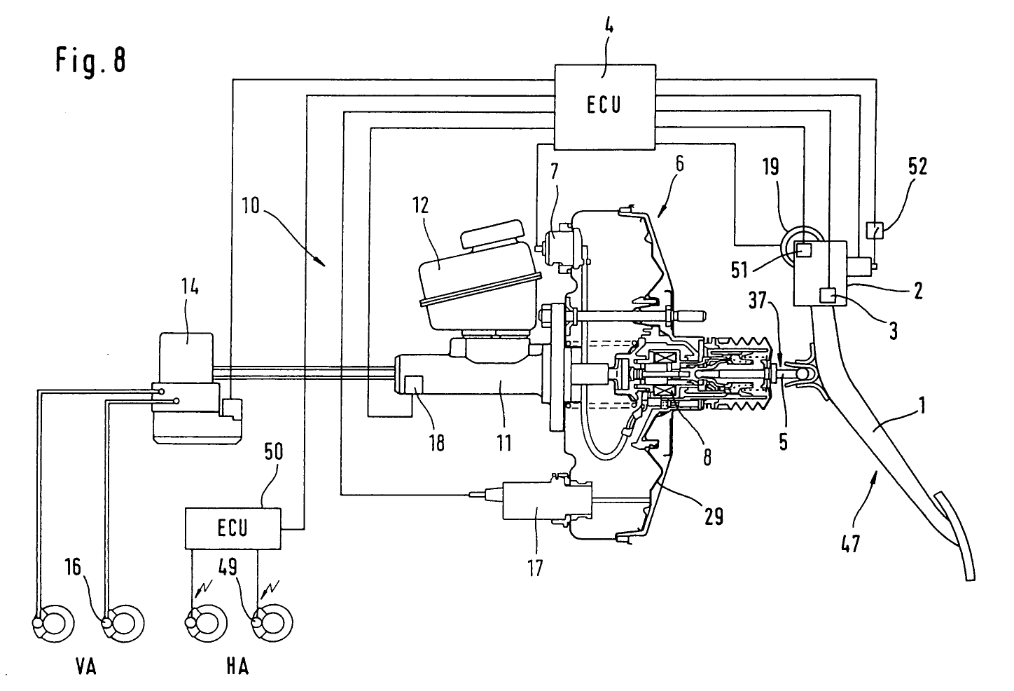

FIG. 8 illustrates a by-wire brake actuation system comprising an electronically operable pneumatic brake booster 6 in connection with two electromechanical wheel brakes 49 for a rear axle being actuatable electromechanically by way of a separate electronic unit (50, ECU), and comprising two electrohydraulically actuatable wheel brakes 16 for a front axle. The hydraulic wheel brakes 16 of the front axle are fed by way of a distributor device (hydraulic unit, HCU; 10) being, in turn, actuated by way of an electronic unit 4 (ECU). Signals of a (diaphragm) travel sensor 17 and a pressure sensor 18 being arranged in the brake circuit of the front wheel brakes 16 are sent to said ECU. Further, ECU 4 receives the signals of two travel sensors or rotary sensors 3, 51, which are allocated to the brake pedal 1 and a simulator (force-feedback pedal) 2 for generating reaction forces. A brake light switch 52 likewise feeds its signal to the ECU 4. ECU 4 together with the booster 6 and the distributor device 10 takes care of supplying the hydraulic wheel brakes 16 with the necessary hydraulic pressure and further permits the actuation of the brake booster 6 independently of the driver, and also the actuation of the simulator 2.

### LIST OF REFERENCE NUMERALS

1 brake pedal
2 simulator
3 actuation sensor
4 electronic unit
5 input member
6 booster
7 connection
8 drive
9
10 distributor device
11 master brake cylinder
12 reservoir
13 valve circuit
14 pump motor
15
16 wheel brakes
17 travel sensor
18 pressure sensor
19 motor
20 clutch
21 clutch shaft
22 rows
23 projection
24 peripheral surface
25 longitudinal bore
26 transmission member
27 collar
28 spring
29 diaphragm plate
30 projection
31 row
32 housing
33 projection
34 projection
35 peripheral surface
36 component
37 actuation component
38 means
39 actuator
40 member
41 spring
42 solenoid
43 ball screw
44 electric motor
45 sleeve
46 hydraulic piston
47 actuation component
49 electromechanical wheel brake
50 electronic unit
51 travel sensor or rotary sensor
52 brake light switch
53 pump
54 high-pressure accumulator
55 pressure chamber
NC solenoid valve
NO solenoid valve
DS1 pressure sensor
DS2 pressure sensor

1-21. (canceled)

22. Brake-by-wire actuator for actuating the brake system of a motor vehicle, comprising a simulator which can be acted upon by a brake pedal, with an output signal of an actuation sensor being sent to an electronic control unit which controls a pressure source in response to the signal of the actuation sensor, and with an output of the pressure source that is connected to a distributor device for the brake force and actuates individual wheel brakes of the vehicle, also comprising means for enabling actuation of the brakes by muscular power within a fallback mode,
wherein a lost travel is provided between a first actuation component such as the brake pedal in particular or a component articulated at the brake pedal and a second actuation component that is connected downstream in the flux of force, in particular an input member, in order to uncouple the first actuation component mechanically from the reactions of force of the motor vehicle brake system in a by-wire mode.

23. Brake-by-wire actuator as claimed in claim 22,
wherein a means is provided in order to automatically reduce the lost travel after a by-wire mode at the commencement of a brake actuation executed by muscular power.

24. Brake-by-wire actuator as claimed in claim 23,
wherein said means may be actuated by means of an electric, electromagnetic, hydraulic, or pneumatic actuator, which will automatically adopt a closing position for reducing the lost travel in the fallback mode.

25. Brake-by-wire actuator as claimed in claim 24,
wherein the means is provided as a clutch between the two actuation components.

26. Brake-by-wire actuator as claimed in claim 25,
wherein the means comprises a block-shaped body which bridges the lost travel between the actuation components in a form-fit manner.

27. Brake-by-wire actuator as claimed in claim 25,
wherein the actuator includes a spring for the elastic preload of the block-shaped body and a solenoid for returning or keeping back the block-shaped body in the opening position.

28. Brake-by-wire actuator as claimed in claim 22,
wherein the pressure source comprises a hydraulic booster with at least one hydraulic pump which is actuatable by electric signals in the by-wire mode, and wherein the actuation in the fallback mode is carried out hydraulically by way of a master brake cylinder.

29. Brake-by-wire actuator as claimed in claim 28,
wherein the pump feeds a high-pressure accumulator.

30. Brake-by-wire actuator as claimed in claim 22,
wherein the pressure source comprises a pneumatic booster which is actuatable by electric signals in the by-wire mode and mechanically by way of the actuation components in the fallback mode.

31. Brake-by-wire actuator as claimed in claim 30,
wherein the pressure source includes a pneumatic booster and additionally a hydraulic pump being actuated, for example, in the event of a defect of the pneumatic booster or when boosting is not sufficient.

32. Brake-by-wire actuator as claimed in claim 30,
wherein the pressure source includes an electromotively driven master brake cylinder.

33. Brake-by-wire actuator as claimed in claim 22,
wherein there is provision of at least one member of the group consisting a travel sensor in a pneumatic booster, a pneumatic pressure sensor in the pneumatic booster, a differential pressure sensor in the pneumatic booster, and a hydraulic pressure sensor in a brake circuit detecting deviations from nominal values, and
wherein the electronic unit on account of detected sufficient deviations detects a malfunction such as the inclusion of air or a circuit failure in the brake system and initiates appropriate safety processes such as the fallback mode in particular.

34. Brake-by-wire actuator as claimed in claim 33,
wherein the travel sensor and the pressure sensor or the differential pressure sensor detects a point of maximum boosting of the booster, and
wherein the hydraulic pump is started by way of the electronic unit.

35. Brake-by-wire actuator as claimed in claim 33,
wherein the travel sensor or the pressure sensor or the differential pressure sensor detects a point of maximum boosting of the booster, and
wherein the hydraulic pump is started by way of the electronic unit.

36. Brake-by-wire actuator as claimed in claim 22,
wherein the simulator includes a motor or a spring used to generate reaction forces.

37. Brake-by-wire actuator as claimed in claim 25,
wherein the position of the point of application of the brake pedal in relation to the subsequent actuation component is adjustable.

38. Brake-by-wire actuator as claimed in claim 37,
wherein the brake pedal is coupled to a clutch shaft pivotally mounted in its longitudinal direction which is longitudinally displaceable relative to the input member in dependence on its rotary position relative to the input member or is in engagement with the input member in an axial direction.

39. Brake-by-wire actuator as claimed in claim 38,
wherein both the clutch shaft and the input member include projections serially arranged in their longitudinal direction in a row, and in a first rotary position of the clutch shaft in relation to the input member, the projections of the clutch shaft and the input member are disengaged, while in a second rotary position at least one projection of the clutch shaft is engaged with a projection of the input member.

40. Brake-by-wire actuator as claimed in claim 39,
wherein several rows of projections are provided at a predetermined angular distance over a periphery of the input member and the clutch shaft.

41. Brake-by-wire actuator as claimed in claim 39,
wherein the clutch shaft is equipped with a longitudinal bore that is open towards the input member, with one end of the input member projecting into said bore, and wherein peripheral surfaces of the end of the input member and of the longitudinal bore in the clutch shaft carry the projections.

42. Brake-by-wire actuator as claimed in claim 38,
wherein the clutch includes a spring whose first end is supported on a housing of the clutch and whose second end is supported on a transmission member, with said transmission member being connectable to the clutch shaft pivotally mounted in its longitudinal direction, with said clutch shaft being longitudinally displaceable in relation to the transmission member in dependence on its rotary position with respect to the transmission member or being in engagement with the transmission member in an axial direction by way of projections.

43. Brake-by-wire actuator as claimed in claim 42,
wherein the clutch shaft is in engagement with the input member and disengaged from the transmission member in at least one first rotary position and is disengaged from the input member and in engagement with the transmission member in at least one second rotary position.
